(19) United States
(12) Patent Application Publication
(10) Pub. No.: US 2002/0019824 A1
(43) Pub. Date: Feb. 14, 2002

(54) Method to generically describe and manipulate arbitrary data structures

(75) Inventors: Karl-Hans Holder, Sindelfingen (DE); Ruediger Kirsch, Schoenaich (DE); Viktor Mihajlovski, Wildberg (DE)

Correspondence Address: IBM Corporation - MS P386, Intellectual Property Law Department, 2455 South Road, Poughkeepsie, NY, 12601, US

(73) Assignee: International Business Machines Corporation, Armonk, NY (US)

(21) Appl. No.: 09/832,703

(22) Filed: Apr. 11, 2001

(30) Foreign Application Priority Data
Apr. 12, 2000 (EP) 00107848.4

(51) Int. Cl. G06F 7/00

(52) U.S. Cl. 707/100

(57) ABSTRACT

A method and system for generically describing and manipulating arbitrary data structures. The method comprises the steps of reading resource-specific information from a resource-specifying source (e.g., an XWL file); specifying the structure comprising the resources; generating hierarchical control information (for example, a tree reflecting the structure); and enabling an access to a desired resource by calling a resource access performer with a respective reference to the resource.

### BACKGROUND OF THE INVENTION

1. Field of the Invention

The present invention relates to improvements in the handling of data managed by a computer system, and in particular it relates to a method and system for generically describing and manipulating arbitrary data structures.

2. Description of the Related Art

Although the present invention has a broad scope it will be described and distinguished from prior art in an embodiment in which the data structures in question are related to data which is managed and used primarily by a computer operating system.

For the purpose of the present invention the term “resources” should be understood as comprising any data item as for example the last name of a user of a computer system, a data set in which the data is stored as an element of it, as well as further structural elements which embed the data in a general, hierarchical context, as for example a file tree, or a data tree.

In particular so-called systems management software needs to handle, i.e. needs to read and update, or delete large numbers of similar resources. In many cases, such systems management software is dedicated to such management in OS/390 system management which is related to mainframe operating system technology OS/390. For each resource to be supported the management software needs to be modified and recompiled since special code must be written which handles the specifics of the respective resource. So, whenever an additional resource is to be supported the code of the supporting software must be modified.

In other contexts as well, there might be a requirement to add a particular attribute to each data set in a situation in which an already large number of data sets exists and must be maintained with a dedicated tool. Such tool, however, is limited to the management of already existing data. Thus, the tool must be extended and must be reedited and recompiled. An example is the RACF ISPF interface in OS/390, which (amongst other things) allows system administrators to manage RACF user IDs and attributes thereof RACF handles data access rights and other security relevant aspects of the operating system OS/390. ISPF is an abbreviation for Interactive System Productivity Facility. To access new attributes in the RACF database it is necessary that the ISPF dialogs include these attributes, meaning that a corresponding version of the ISPF interface is needed.

Further, in many situations the above-mentioned resources are shared between a plurality of management systems, as for example a plurality of computer users might access a UNIX environment as well as a Windows NT environment. Thus, any of the changes made to user data should be consistently performed in a UNIX systems management tool and in a Windows NT systems management tool in order to avoid problems resulting from differences there between

Thus, it is desirable to be able to support additional resources without the need to modify the code of the respective management software.

### SUMMARY OF THE INVENTION

It is thus an object of the present invention to facilitate the access to data which is specifically managed by one or more associated data management tools.

This and other objects of the invention are achieved by the features stated in the independent claims. Further advantageous arrangements and embodiments of the invention are set forth in the subclaims.

The approach introduced by the invention allows one to model data available in different kinds of repositories in a uniform way and also allows one to access, process and update this data in a generic way, independent of the data and repository type. The data in the repositories are further referred to herein as a resource or resources.

According to a basic aspect the present invention reveals a data processing engine that provides basic functionality for data access, composition and navigation. This engine further provides an API to trigger data access, processing and update and also an architectured interface for the desired resource access.

Such interface, further referred to herein as a “performer”, implements a well-defined set of logical operations allowing one to obtain access to the resource, to navigate in the resource data and to retrieve and update data items in the resource. The abstract denominations of these operations are getNode, createNode, deleteNode and update. These operations as implemented by a resource access interface, i.e. by a parser, or a modifier, which parses the physical resource comprise device-granting access to data items within it (getNode) and modify it upon request (e.g., createNode, deleteNode, update). The update operation is directed to the resource as a whole and can advantageously comprise commit facilities.

Thus, the access method of the present invention basically comprises the following steps: (1) using a definition of or defining at least physical and/or logical parameters required for locating the desired resource, (2) reading resource-specific information from a resource-specifying source, advantageously an XML file specifying the structure comprising the resource, (3) generating hierarchical control information reflecting the structure, and (4) enabling an access to the desired resource by calling a resource access performer with at least one of the parameters and by evaluating the control information.

The above-mentioned engine processing is directed by a data model definition that will further be referred to herein as a “schema”. A preferred schema language is an XML language as already indicated shortly above. XML is preferred concurrently because of its recent popularity and availability of tools like parsers, editors, etc. Another option would have been a special-purpose schema language, the language itself not being relevant for the invention. It should be noted that future languages may be suited as well, if appropriate.

The parameters associated with logic operations of the resource access performer are the type and node names as defined in the schema.

The capabilities of the engine are reflected by the constructs available in the schema which consist of simple data types and composition methods like a “record” and “list” construction. New data types can be constructed by composition of basic and other composed data types. This makes the engine particularly suitable for processing both, flat and tree-structured, hierarchical data, since no manual programming is required in these cases.

If resource data structures that cannot be expressed with the built-in capabilities as, e.g., complex relations between data items or “exotic” data types should occur, the schema allows one to extend the engine capabilities through particular plug-in code that is callable by the engine.

As is a basic prerequisite of the present invention the resource access is not performed by the engine itself but by respective dedicated resource access interfaces that act on behalf of the engine to access data as defined by the schema.

The resource access interfaces are provided for all resources referred by the schema. Resource access may for example consist of syntax-driven parsers for PARMLIB members when applied for IBM OS/390 computer technology. More sophisticated resource access mechanisms can access a database or directory servers.

As soon as data-processing and resource access interfaces exist it is possible to combine them in the schema and add new functionality or new resources easily. For example, if data associated to a person is stored in different repositories like directories or inventory databases, it is possible to keep the data synchronized by defining a schema describing the data relationships and providing resource access interfaces for the repositories.

Such a processing is done as summarized below.

The engine of the present invention is typically invoked via the API to perform an action like retrieve one or more values from the resources or update some values in one or more resources. For this purpose the engine constructs a tree structure according to the schema specification for this resource. Such tree structure will be referred to as a resource tree and its nodes as resource nodes.

The engine then locates the appropriate nodes in the tree via its built-in navigation capabilities or by using plug-in logic. If necessary, additional nodes are constructed to satisfy the schema requirements. In order to populate the resource tree, to retrieve or update the value of a resource node and for the creation and/or deletion of resource nodes, the responsible resource access interface is called.

When all API requests have been processed, the original resources are updated to reflect the state of the resource tree as maintained by the engine.

One core idea of this disclosure is the concept of data typing in the data modeling schema which is used to describe the resources to be manipulated:

The flexibility and extendibility of the general processing engine of the present invention to support new resources results from the way in which the types of the resources and their contained parameters can be defined:

According to a fundamental aspect of the method of the present invention a predefined set of data types is used as they are the scalar, i.e., simple data types like string, boolean, integer, as well as predefined methods, as are for example a list generator or an array generator for modeling compound data types out of the plurality of scalar data types.

Each scalar data type can advantageously be implemented by plugging in a Java class. Such plug-in is basically responsible for validating user input.

To support a new resource, additional scalar and non-scalar types can be defined via the XML tag TYPEDEF class=. . . This means that the concept of the present invention can be readily used when the desired additional attributes of be managed by a management tool as it was described when discussing prior art.

The class attribute defines the plug-in code which handles value checking for the type. This class can be derived from the before-mentioned built-in classes.

Further, the concept of the present invention is able to be extended by adding specific behavioral aspects of a data type. Such an extension can be advantageously done with an XML tag FUNCTION class=. . .

Further, a data type may have relations to other data types, i.e., instances of that data type may have interdependencies with each other or with instances of other types across the repository of resources. This can advantageously be described with an XML ASSOCIATION tag. This allows one to specify plug-in code as well, and in addition, it allows one to reference the involved data items by name.

The above mentioned schema may advantageously comprise an evalution of semantic relations between data stored in one or more of such resources. This enables for providing consistency in data updates in the case of interdependencies between related data. This is of particular importance when the same resource is shared between a plurality of operating systems, or, generally, when the data is distributed over a plurality of locations in a network.

Further, the method of the present invention can be performed request-driven because a request API is advantageously usable with the method of the present invention. Requests may be issued interactively by the user, or, in any kind of automatic process management, like batch queues, etc..

The mechanism described above allows one to define data types which can serve as a set of building blocks; they can be reused and combined to describe the structure and behavior of any resource to be manipulated. With each recombination, the behavior of the new data structure can be adapted via the tags FUNCTION and ASSOCIATION.

XML can be advantageously used to describe resources in the way outlined above. This description is translated into an abstract internal representation of the structure of the resource together with its contained parameters. Such representation can be interpreted by the generic processor of the present invention to create any number of data instances with the defined structure and behavior, and to derive an access path to the real resource data in persistent storage, i.e., to do a mapping from the higher-level resource description to the concrete structure in which the resource is actually physically stored on disk, for example.

This in turn allows one to create and manipulate any instance data which is valid according to these descriptions, by means of the standardized API offered by the generic processor of the present invention and thus allows one to implement generic read/update operations to the real resource.

### BRIEF DESCRIPTION OF THE DRAWINGS

The present invention is illustrated by way of example and is not limited by the shape of the figures of the accompanying drawings in which:

FIG. 1 is a schematic representation showing the basic way of combining elementary building blocks to build up any desired resource construct reflecting the logical resource(s) to be managed (upper part), and the means by which this is done (lower part),

FIG. 2 is a schematic representation showing an overview of the processing when the method of the present invention is applied,

FIG. 3 is a schematic representation showing the basic steps of the method of the present invention, and,

FIG. 4 is a schematic representation showing an overview over the most essential logical and physical elements used.

### DESCRIPTION OF THE PREFERRED EMBODIMENT

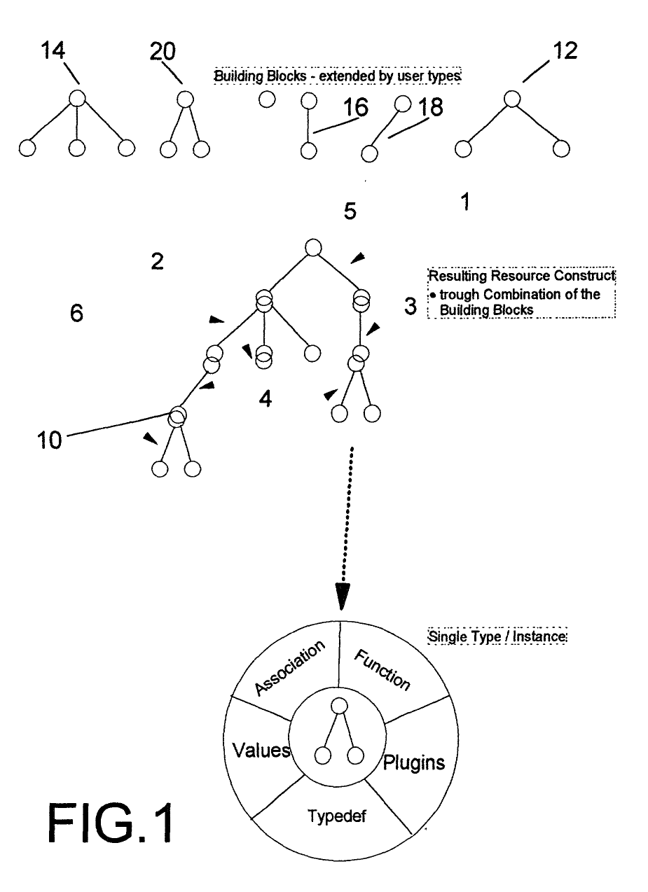

With general reference to the figures and with special reference now to FIG. 1, an example for a simple data model definition is given which drives the access on the physical data.

At the upper margin six exemplarily chosen building blocks are depicted by the help of which a resource structure 10 can be combined according to the present invention. First, a building block 12 is applied whereby a resource structure having a main node with two associated child nodes is constructed, see arrow 1.

Then, as indicated by arrow 2, a further building block 14 is combined with its father node connected to the left child node of building block 12. Then, in a further step indicated by arrow 3, the building block 16 is connected with the remaining child node of building block 12 and, further, a building block 20 is appended to the child node of building block 16.

Then, in the left branch again, a building block 18 is appended to the leftmost child node of building block 14, see arrow 5. Then, building block 20 is appended to the child node of building block 18, see arrow 6.

As is revealed easily from the drawing, any desired tree structure may be constructed from one or more basic building blocks. It should be noted that it is just a design decision how many elements and different building blocks might be comprised of the respective “tool box” as long as the most primitive building blocks, i.e. a single node and a pair of a father node and a child node, are members of the tool box. It should be noted that more than one new building block can be added to any desired father node, too.

The above-mentioned XML tags ASSOCIATION and FUNCTION are depicted in the lower part of FIG. 1, and other tags like VALUES, TYPEDEF and PLUG-INS are depicted in order to illustrate the above-mentioned flexibility of the concept of the present invention to describe any structure or behavior of any resource to be manipulated.

According to this preferred embodiment of the resource access method of the present invention, a predefined set of data types is used as mentioned above. Each scalar data type is advantageously implemented in a Java class.

Such an implementation is proposed to be basically responsible for validating an user input.

A scalar type is defined via the XML tag TYPEDEF class=<attribute>. . .

The class attribute defines the plug-in code which handles value checking for the type. This class can be derived from built-in classes.

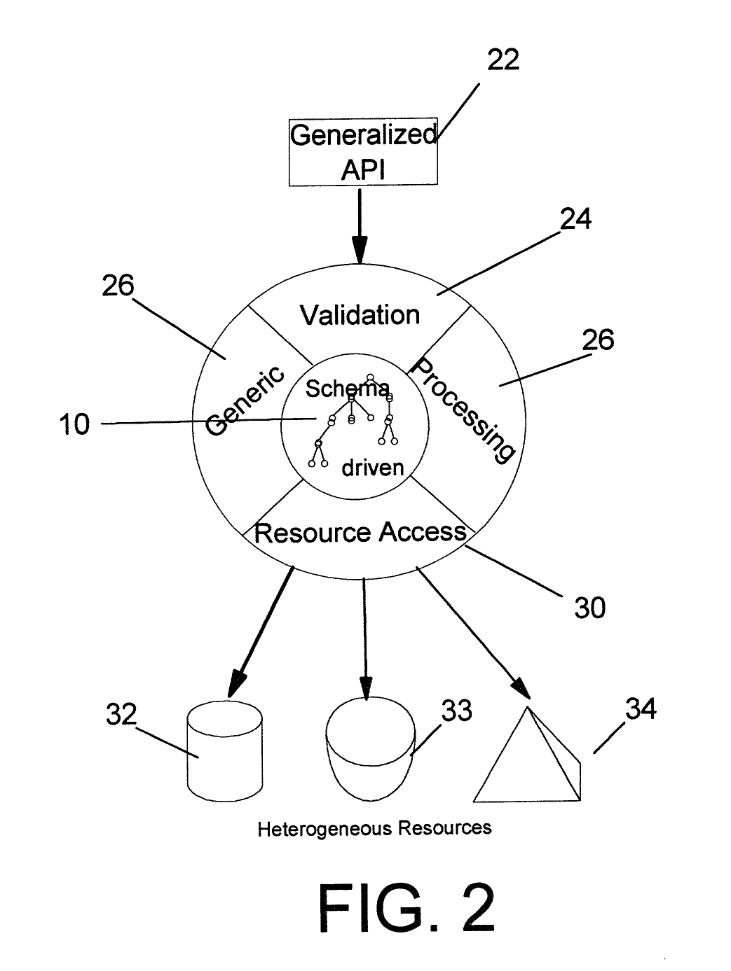

With reference now to FIGS. 2, 3 and 4, an overview of the processing will be given next below illustrating a situation when the method of the present invention is applied, for example by a system manager with the help of a resource access management tool implementing the method of the present invention in a heterogeneous network comprising a UNIX part and a Windows NT part and a plurality of users working in it.

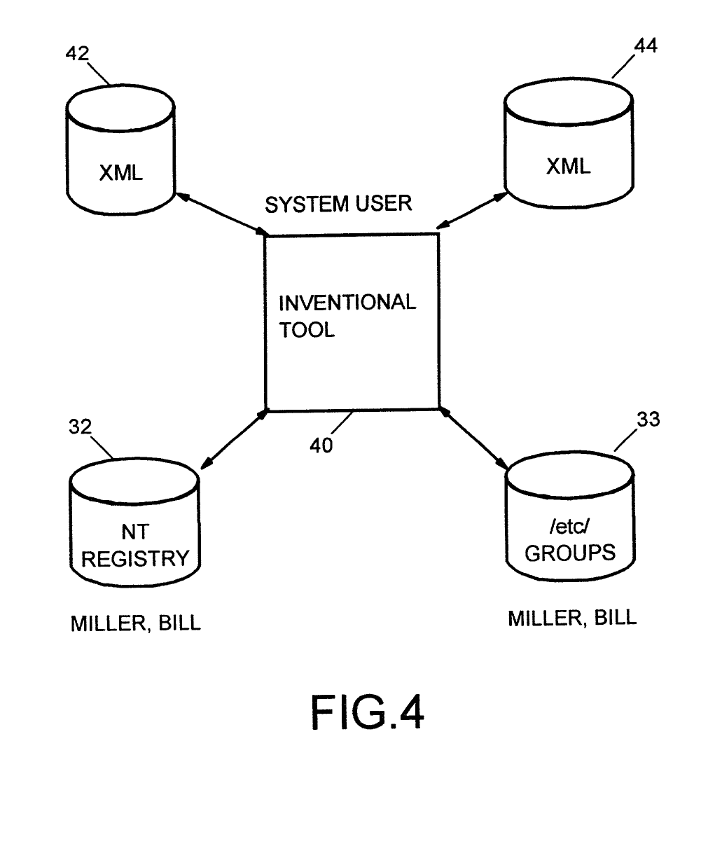

The last name of one of the users is assumed to be Miller and the first name is assumed to be Bill. As schematically depicted in FIG. 4 a system administrator is ordered to grant him access to a color printer which in turn is an operating system resource of both the Windows NT environment and the UNIX environment.

Thus, in a first step 310 the system administrator starts a tool on a computer system associated with him on which the method of the present invention is implemented in the form of a program product. This is symbolically expressed in FIG. 2 by the generalized application program interface (API) 22.

The functional scope of the present invention is symbolically depicted in the middle part of FIG. 2 where two concentric circles are depicted. In the outer circle basically three different processing areas are depicted: validation 24 of user input, a generic processing part 26 and a resource access performer part 30 which is intended to cooperate with an interface comprised of the present invention and which is actually realizing the physical access to data.

The validation part 24 is intended to cover all work which of be done when any user input which is intended to specify a search on data to be accessed is checked for validity. Thus, a number of check routines filled with a plurality of check code adapted to the individual application area of the tool of the present invention can be present.

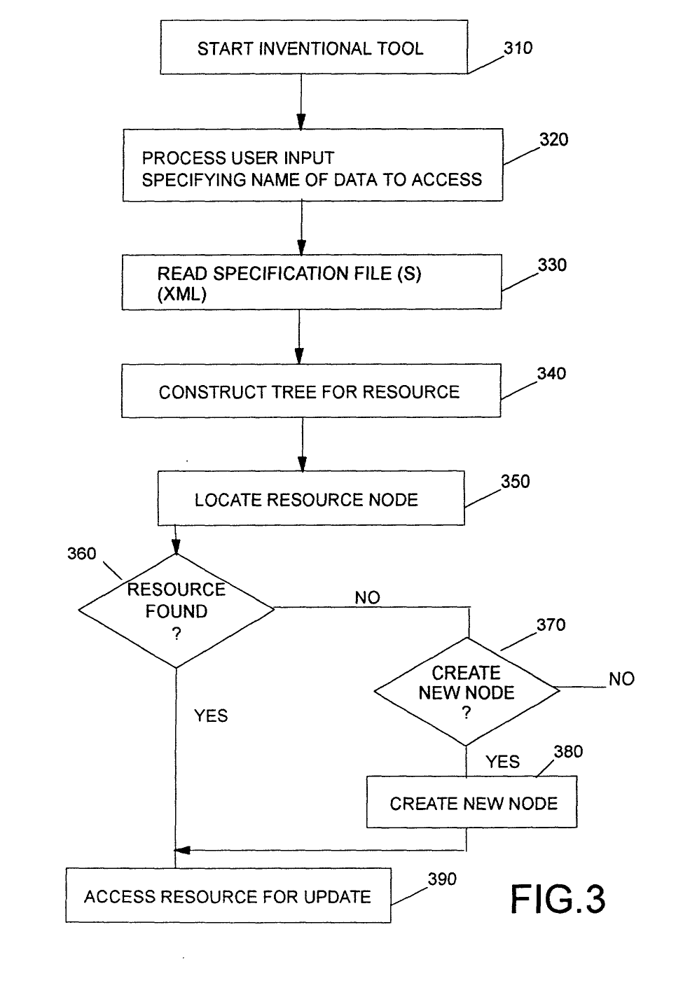

With reference to FIG. 3 the system administrator enters some data specification for data which he intends to access. The input is then processed, for example, is checked for validity as mentioned above, step 320. In the particular case now in which the end-user Bill Miller shall be granted access to the particular color printer which may be located and identified by the associated room number of the building, the printer server is specified so that it can be identified throughout the network. Thus, the network node specifying the printer server is entered by the system administrator.

In this simple example two different resources 32, 33 —see FIG. 4 now—are updated: the first is the user group management file 33 in the UNIX directory system which is found under /etc/groups and is updated in such a manner that the UNIX user ID for Mr. Miller is added to a group having write access to the printer, and second, the Windows NT registry 32 is updated as well to define the printer to the user, both updates being necessary for adding the granted access rights to Mr. Bill Miller.

In order to do that the access method of the present invention constructs now a tree structure according to the schema specification for both resources 32, 33. The schema specification for the UNIX resource is advantageously stored according to the present invention in an XML file, for example being named groups.xml, and the schema specification for the Windows registry is specified in a respective registry.xml file, as well. A corresponding sequence of steps 330, 340 is depicted in FIG. 3. Two respective exemplary XML files are given next below for the sake of complete understanding:

<?xml version=“1.0” ?>
<!DOCTYPE BINDSUPPORT SYSTEM “bindSupport.dtd” >
<BINDSUPPORT SERVICE-NAME=“REGISTRY”>

<RECORD ID=“REGISTRY”>

<ENTRY TYPE=“HKEY_USERS”/>

</RECORD>
<RECORD ID=“HKEY_USERS”>

<ENTRY TYPE=“PrinterList”/>

</RECORD>
<LIST ID=“PrinterList”>

<ENTRY TYPE=“Printer”/>

</LIST>
<RECORD ID=“Printers”>

<ENTRY NAME=“PrinterName” TYPE=“STRING”/>

</RECORD>

</BINDSUPPORT>

and

<?xml version=“1.0” ?>
<!DOCTYPE BINDSUPPORT SYSTEM “bindSupport.dtd”>
<BINDSUPPORT SERVICE-NAME=“GROUP”>

<LIST ID=“GROUPS”>

<ENTRY TYPE=“GROUP”/>

</LIST>
<RECORD ID=“GROUP”>

<ENTRY NAME=“GID” TYPE=“INTEGER”/>
<ENTRY TYPE=“USERS”/>

</RECORD>
<LIST ID=“USERS”>

<ENTRY TYPE=“USER”/>

</LIST>
<RECORD ID=“USER”>

<ENTRY NAME=“USERID” TYPE=“STRING”/>

</RECORD>

</BINDSUPPORT>

The tree construction is done as it is described above with reference to FIG. 1.

Then, in a further step 350 the appropriate nodes are located in the respective tree via built-in navigation capabilities or, by using a plug-in logic, dependent on what is specified in the schema file. The resource access interface is called if necessary to obtain data from the physical resources, i.e., from the registry 32 or the /etc/groups file 33.

By using the structural information contained in the schema and by calling the resource access performer 30 through the resource access interface an instance tree is built. This instance tree represents the actual resource contents in addition to the resource's structure defined in the schema. Therefore the resource access interface is called to construct the nodes in this tree according to the schema and to fill them with data from the actual resource.

If it turns out that an additional node must be constructed in order to satisfy the schema requirements this can be done advantageously according to the basic concepts of the present invention by adding some of the building blocks mentioned and described with reference to FIG. 1 and without any change required in the system management tool. This is a remarkable advantage compared to prior art systems management system tools.

The additional optional creation of new nodes is depicted with the NO branch of decision 360 and the followed decision 370 and step 380, respectively. The NO branch of decision 370 leads to an abort of the respective node creation. Thus, in the cases of both the YES branch and the NO branch of decision 360, the resource can be accessed for update in a step 390 by calling the respective resource access interface. The resource access interface is depicted at the respective location in FIG. 2 next to the resources 32, 33, 34 depicted in the lower part thereof.

It should be noted that the present invention does not extend to cover and disclose any resource access module interacting with the resource access interface for any data. Instead, it is stressed that nearly any data is reachable with the method disclosed in the present invention as long as the logical data structure of the resource is specified sufficiently in the associated XML file.

Thus, the present invention proposes and provides for using some interface to a specific resource access management tool which is advantageously a well architectured interface.

The architectured interface contains operations to access data items in the resource such as operation getNode, to create and delete them, such as operations createNode, deleteNode and to commit the modifications to the resource such as operation update. Further resource-specific parts of the interface could consist of the node in a network, the name, the type and the absolute path in order to update the resource.

This is depicted with the last step 390 in FIG. 3.

With reference to FIG. 4 the situation is depicted schematically. The system user's computer 40 runs the access management tool of the present invention which reads information in both a Windows NT resource-specifying source 42 and a respective source 44 for the UNIX system. The paths depicted for accessing the Windows NT registry 32 and the UNIX /etc/groups file 33 are depicted at the left and the right margins, respectively. The path names can easily be combined with the above mentioned scalar types string. The absolute path name can be generated by a method RECORD, as it was mentioned above. Any value, e.g. Miller-Bill or his user ID can be constructed with the above mentioned scalar data types.

In order to guaranty, however, that the access right to the printer in question is updated in both operating systems consistently, the above mentioned ASSOCIATION tag provided by XML can be advantageously utilized. As a result, the system administrator does not need to add the respective two resources 32, 33 by himself, and he does not need to control consistency, as well.

In the foregoing specification the invention has been described with reference to a specific exemplary embodiment thereof It will, however, be evident that various modifications and changes may be made thereto without departing from the broader spirit and scope of the invention as set forth in the appended claims. The specification and drawings are accordingly to be regarded as illustrative rather than in a restrictive sense.

The present invention can be realized in hardware, software, or a combination of hardware and software. An access management tool according to the present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system is able to carry out these methods.

Computer program means or computer program in the present context mean any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for providing access to resources comprising the steps of:
defining physical and/or logical parameters required for locating the desired resource;
reading resource-specific information from a resource-specifying source specifying a structure comprising said resource,
generating hierarchical control information reflecting said structure; and
enabling access to a desired resource by calling a resource access performer with at least one of said parameters and evaluating said control information.

2. The method of claim 1 further comprising the step of:
automatically triggering a semantic evaluation of the contents of a resource desired to be updated when said resource is referenced in calling said resource access preformer.

3. The method of claim 1 in which said resource-specifying source is an XML file.

4. The method of claim 1 in which said hierarchical control information is defined in a data modeling schema comprising simple data types and at least one composition method for recursively constructing complex data types.

5. The method of claim 4 in which said schema comprises relations between data stored in one or more of said resources.

6. The method of claim 1 in which said resources are shared between at least two different operating systems.

7. The method of claim 1 further comprising the step of:
performing extended processing on said resources as defined in a Java class.

8. A computer system having means for performing the steps of the method of claim 1.

9. A computer program for execution in a data processing system comprising computer program code portions for performing respective steps of the method of claim 1.

10. The computer program of claim 9 comprising an application interface for triggering requests for resource data processing from an application and an architectured interface for resource access.

11. The computer program of claim 10 in which said interface comprises one or more calls to at least one resource access performer.

12. A computer program product stored on a computer-usable medium comprising computer-readable program means for causing a computer to perform the method of claim 1.
